(19) United States
(12) Patent Application Publication
(10) Pub. No.: US 2008/0267517 A1
(43) Pub. Date: Oct. 30, 2008

(54) IMAGE PROCESSING APPARATUS AND CONTROL METHOD THEREOF

(75) Inventors: Noboru Hamada, Kawasaki-shi (JP); Naohiro Taguchi, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/017,696

(22) Filed: Jan. 22, 2008

(30) Foreign Application Priority Data
Apr. 26, 2007 (JP) 2007-117739

(51) Int. Cl. G06K 9/46

(52) U.S. Cl. 382/238

(57) ABSTRACT

An image processing apparatus is provided which can restore original data by combining divided data without requiring information about the number of divisions and about succeeding data. To achieve this, the image processing apparatus includes a dividing section for successively dividing the original data at a data size predetermined with respect to a prescribed two-dimensional code image; and a section for assigning a final flag indicating that the data is final data to the data divided lastly from the original data, and for assigning to the other data an ordinary flag indicating that the other data is not the final data.

### BACKGROUND OF THE INVENTION

1. Field of the Invention

The present invention relates to an image processing apparatus and a control method thereof capable of handling two-dimensional code images.

2. Description of the Related Art

A technique is well known which generates two-dimensional code image data (a QR code or watermark or bar-code and the like) by performing encoding processing on original data. In the technique like this, since the maximum size of the two-dimensional code image data is determined (such as 4 cm×4 cm) in advance, when the amount of the original data is large, the original data is divided into appropriate size of data (e.g. within 2M bytes).

Then, by performing two-dimensional encoding processing of each of the plurality of divided data thus obtained, a plurality of two-dimensional code image data are generated. In the present specification, the plurality of data obtained by dividing the original data are each referred to as divided data or cutout data.

However, as for an apparatus that performs the decoding processing on the two-dimensional code image data, there is one problem. The problem is that simply two-dimensionally decoding the two-dimensional code image data cannot restore the original data because of the confusion as to the sequence of the data obtained by decoding.

In view of this, the technique disclosed in Japanese Patent Laid-Open No. 2004-295523 generates a quasi packet (simply called “packet” from now on) by combining the divided data with an identifier indicating the sequence of the divided data, and generates the code image data by performing the encoding on the packet.

However, in the technique disclosed in Japanese Patent Laid-Open No. 2004-295523, none of the packets includes an identifier that clearly indicates combining completion of the divided data. In other words, no packet includes an identifier “indicating that the packet is the final packet”. In addition, no packet includes an identifier “indicating the total number of the packets”.

Accordingly, the apparatus that performs the decoding processing of the plurality of code image data cannot decide as to whether it completes the decoding of all the two-dimensional code image data.

### SUMMARY OF THE INVENTION

The present invention is implemented to solve the foregoing problems. It is therefore an object of the present invention to provide the following image processing apparatus and control method thereof.

In the first aspect of the present invention, there is provided an image processing apparatus comprising: cutout means for cutting out data with a data size predetermined with respect to a two-dimensional code image one by one from original data; and means for assigning, to data cut out lastly from the original data, a final flag indicating that the data is final data, and for assigning, to other data, an ordinary flag indicating that the other data is not the final data.

In the second aspect of the present invention, there is provided an image processing apparatus comprising: receiving means for successively receiving data that includes data cut out from original data one by one and an identifier and a flag which are added to each cutout data, the identifier being used for identifying first previous cutout data as a combining party of the cutout data, and the flag indicating whether the cutout data is final cutout data or not; means for generating a two-dimensional code image by two-dimensionally encoding information including the cutout data, the identifier and the flag which are contained in the data received by said receiving means; and image forming means for forming an image of the generated two-dimensional code image on a printing medium.

In the third aspect of the present invention, there is provided an image processing apparatus comprising: reading means for reading a plurality of two-dimensional code images that are formed on a printing medium by two-dimensionally encoding data that includes data cut out from original data one by one and an identifier and a flag which are added to each cutout data, the identifier being used for identifying first previous cutout data as a combining party of the cutout data, and the flag indicating whether the cutout data is final cutout data or not; two-dimensional decoding means for two-dimensionally decoding the two-dimensional code images successively; and combining means for combining, every time said two-dimensional decoding means performs two-dimensional decoding, a combination of combinable data first if the combination is found in the two-dimensionally decoded cutout data according to the cutout data, the identifier and the flag which are two-dimensionally decoded.

In the fourth aspect of the present invention, there is provided a method of controlling an image processing apparatus comprising: a cutout step in which control means of said image processing apparatus cuts out data with a data size predetermined with respect to a two-dimensional code image one by one from original data; and a step in which said control means assigns, to data cut out lastly from the original data, a final flag indicating that the data is final data, and assigns, to other data, an ordinary flag indicating that the other data is not the final data.

In the fifth aspect of the present invention, there is provided a control method of an image processing apparatus comprising: a step of successively receiving, under control of control means of said image processing apparatus, data that includes data cut out from original data one by one and an identifier and a flag which are added to each cutout data, the identifier being used for identifying first previous cutout data as a combining party of the cutout data, and the flag indicating whether the cutout data is final cutout data or not; a step in which said control means generates a two-dimensional code image by two-dimensionally encoding information including the cutout data, the identifier and the flag which are contained in the data received at the step of receiving; and a step of forming an image of the generated two-dimensional code image on a printing medium under control of said control means.

In the sixth aspect of the present invention, there is provided a control method of an image processing apparatus comprising: a step of reading, under control of control means of said image processing apparatus, a plurality of two-dimensional code images that are formed on a printing medium, the two-dimensional code image being generated by two-dimensionally encoding data that includes data cut out from original data one by one and an identifier and a flag which are added to each cutout data, the identifier being used for identifying first previous cutout data as a combining party of the cutout data, and the flag indicating whether the cutout data is final cutout data or not; a two-dimensional decoding step in which said control means two-dimensionally decodes the two-dimensional code images successively; and a step in which said control means combines, every time two-dimensional decoding is performed at the two-dimensional decoding step, a combination of combinable data first if the combination is found in the two-dimensionally decoded cutout data according to the cutout data, the identifier and the flag which are two-dimensionally decoded.

In the seventh aspect of the present invention, there is provided an apparatus comprising: receiving means for receiving data to be subjected to two-dimensional encoding; and means for performing two-dimensional encoding of cutout data in a manner that the cutout data constitutes a lump of two-dimensional code, by cutting out data with an amount of data to be subjected to the two-dimensional encoding as the lump of two-dimensional code from the data to be subjected to the two-dimensional encoding received by said receiving means, wherein said means for performing the two-dimensional encoding starts its two-dimensional encoding before said receiving means receives all the data to be subjected to the two-dimensional encoding.

Each of the steps of each of the foregoing image processing methods can be constructed as a program to be executed by a computer included in each of various image processing apparatuses or information processing apparatuses. Then, causing the computer to read the program enables the computer to carry out the image processing method. In addition, the program can be read into the computer via a computer readable storage medium that records the program.

In the present specification, it is assumed that the term “image processing apparatus” refers to not only a dedicated image processing apparatus or an image forming apparatus, but also a general-purpose information processing apparatus capable of executing the processing in accordance with the present invention.

According to the present invention, the final flag enables identification of the final divided data. This eliminates the need for grasping the number of divisions and the like, and makes it possible for each division to perform pipeline processing of prescribed processing on each divided data.

Furthermore, providing the identifier that indicates the first previous divided data of the original data as the combining party of the present data makes it possible to restore the original data by combining the divided data without information about the original data or information about the data following the present data. This enables starting prescribed processing, that is, two-dimensional encoding processing and the like, of the divided data for each division of the original data regardless of the succeeding data.

Moreover, since the prescribed processing can be started for the divided data for each division, it is possible to reduce the memory consumption during execution of the dividing processing and processing delay as compared with the conventional apparatus which starts the prescribed processing after all the divided data are prepared. Such an effect increases with an increase in the number of divisions of the data and the data size.

Further features of the present invention will become apparent from the following description of exemplary embodiments (with reference to the attached drawings).

### BRIEF DESCRIPTION OF THE DRAWINGS

FIG. 1 is a block diagram showing an entire configuration of a printing system;

FIG. 2 is an exterior view of an image forming apparatus;

FIG. 3 is a block diagram showing a configuration of a controller;

FIG. 4 is a schematic diagram illustrating tile data;

FIG. 5 is a block diagram showing a configuration of a scanner image processing section;

FIG. 6 is a block diagram showing a configuration of a printer image processing section;

FIG. 7 is a diagram showing an example of an initial screen of an operating section;

FIG. 8 is a diagram showing types of a cutout packet;

FIG. 9 is a diagram showing a data example in accordance with an XML format defining a cutout packet structure;

FIG. 10 is a flowchart illustrating an example of data dividing/two-dimensional encoding processing;

FIG. 11 is a flowchart illustrating an example of data combining processing;

FIG. 12 is a flowchart illustrating an example of two-dimensional decoding/reencoding processing;

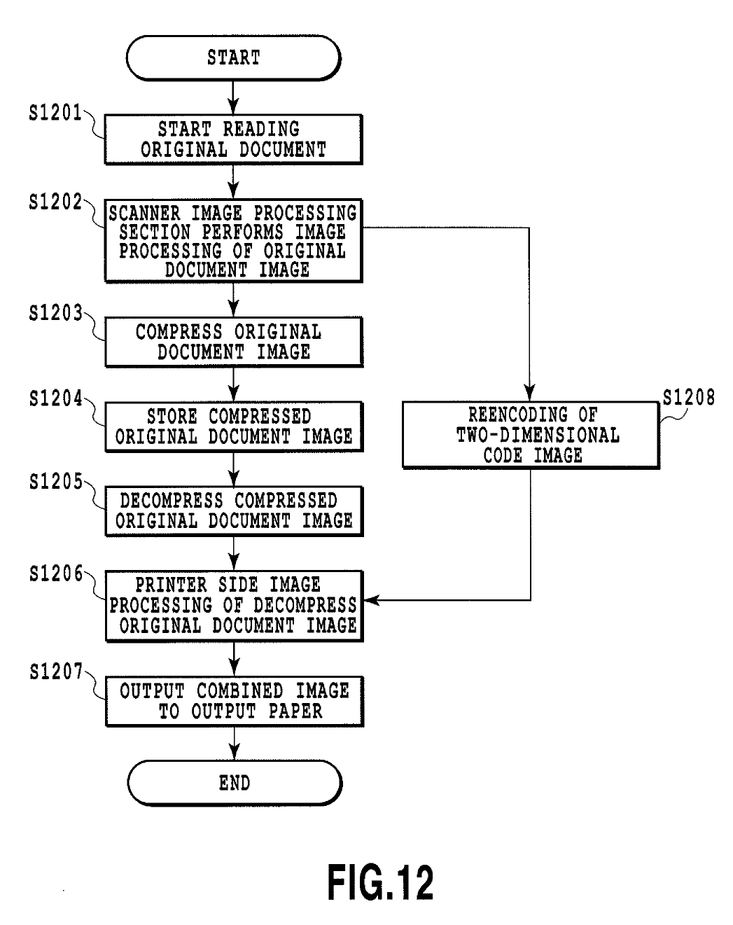

FIG. 13 is a block diagram showing a configuration of dividing/two-dimensional encoding processing in an information processing apparatus;

FIG. 14 is a block diagram showing an internal configuration of an ordinary information processing apparatus;

FIG. 15 is a block diagram showing a configuration of data dividing processing in the information processing apparatus; and

FIG. 16 is a flowchart illustrating an example of the data dividing processing.

### DESCRIPTION OF THE EMBODIMENTS

The best mode for implementing the present invention will now be described with reference to the accompanying drawings.

### First Embodiment

First, a first embodiment in accordance with the present invention will be described with reference to the accompanying drawings.

### <Printing System>

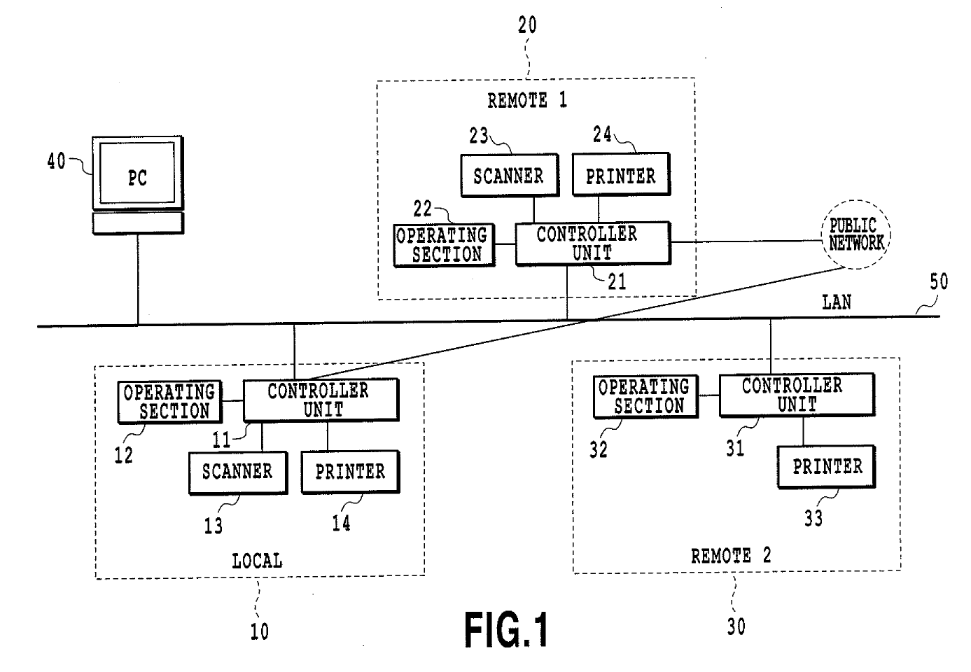

FIG. 1 is a block diagram showing a configuration of a printing system of an embodiment in accordance with the present invention.

A host computer (referred to as “PC” from now on) 40 has functions of the so-called personal computer. The PC 40 can transmit and receive files using an FTP or SMB protocol via a LAN 50 or WAN, or can transmit and receive electronic mail. In addition, the PC 40 can issue a printing command to image forming apparatuses 10, 20 and 30 via a printer driver.

The system as shown in FIG. 1 has the host computer 40 and three image forming apparatuses (10, 20, 30) connected to the LAN 50. The printing system in accordance with the present invention, however, is not limited to these numbers of devices connected. In addition, although the present embodiment employs the LAN as a connecting method between apparatuses, it is not limited to that. For example, any networks such as a WAN (public networks), serial transmission systems such as a USB, and parallel transmission systems such as a Centronics interface and SCSI are applicable.

The image forming apparatuses 10 and 20 as shown in FIG. 1 have the same configuration. The image forming apparatus 30 is an image forming apparatus having only a printing function, and does not have a scanner section which the image forming apparatus 10 or 20 has. In the following description, for the sake of simplicity, focusing attention to the image forming apparatus 10 in the image forming apparatuses 10 and 20, its configuration will be described in detail.

The image forming apparatus 10 comprises a scanner section 13 constituting an image input device, a printer section 14 constituting an image output device, a controller 11 as a control means for performing operation control of the image forming apparatus 10 in its entirety, and an operating section 12 constituting a user interface (UI).

### <Image Forming Apparatus 10>

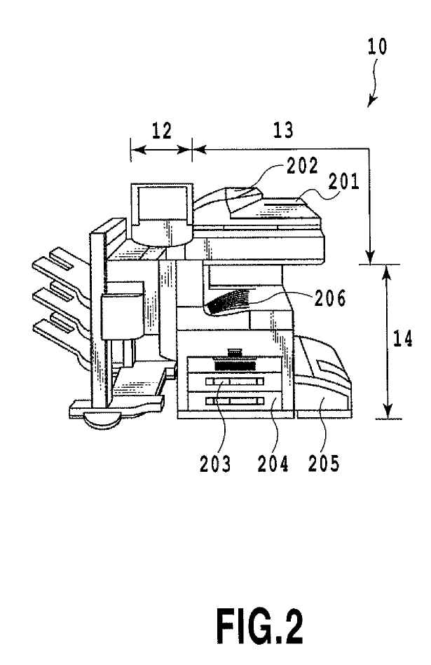

An external appearance of the image forming apparatus 10 is shown in FIG. 2.

The scanner section 13 converts image information into an electric signal by inputting to a CCD the reflected light obtained by performing exposure scanning of the image on an original document. The scanner section 13 further converts the electric signal to a luminance signal consisting of R, G, and B colors, and supplies the luminance signal to the controller 11 as image data.

The original document is placed on a tray 202 of a document feeder 201. When a user instructs to start reading from the operating section 12, the controller 11 gives the scanner section 13 an original document read command. Receiving the command, the scanner section 13 feeds the original document one by one from the tray 202 of the document feeder 201, and reads the original document. As for the reading method of the original document, instead of the automatic feeding method using the document feeder 201, a method is also possible which scans the original document by placing it on a glass plate not shown and by moving an exposure section.

The printer section 14 is an image forming device for forming images on paper (printing medium) on the basis of image data received from the controller 11. In the present embodiment, although the image forming system consists of an electrophotographic system using a photoconductive drum or a photoconductive belt, the present invention is not limited to it. For example, an ink-jet system is also applicable which expels inks from a minute nozzle array to print on paper. The printer section 14 includes a plurality of paper cassettes 203, 204, and 205, which enable selection of a different paper size or different paper direction. A paper output tray 206 receives paper after printing.

### <Controller 11>

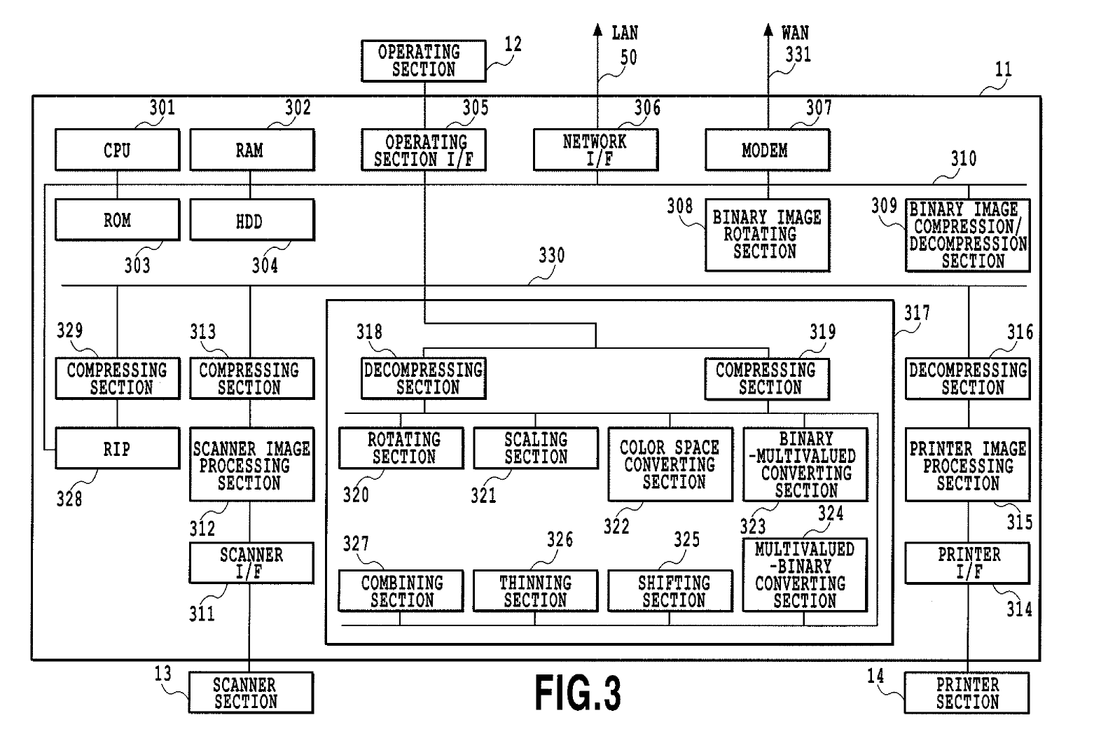

FIG. 3 is a block diagram for explaining the configuration of the controller 11 of the image forming apparatus 10 in more detail.

The controller 11 is electrically connected to the scanner section 13 and printer section 14 on one hand, and to the PC 40 or external apparatus via the LAN 50 or WAN 331 on the other hand. This enables the input and output of the image data and device information.

A CPU 301 achieves centralized control of accesses to individual devices connected thereto according to control programs and the like stored in a ROM 303, and centralized control of various processings carried out inside the controller 11. A RAM 302, which is a system work memory for the CPU 301 to operate, is a memory for temporarily storing image data. The RAM 302 consists of an involatile SRAM that retains the stored contents after the power off and a DRAM whose contents are erased after the power off. The ROM 303 stores a boot program and the like of the apparatus. An HDD 304 is a hard disk drive capable of storing system software and image data.

An operating section I/F 305 is an interface for connecting a system bus 310 and the operating section 12. The operating section I/F 305 receives the image data to be displayed on the operating section 12 from the system bus 310 and supplies it to the operating section 12, and supplies the information input from the operating section 12 to the system bus 310.

A network I/F 306 is connected between the LAN 50 and the system bus 310, and performs input and output of information between another apparatus connected to the LAN 50 and the controller 11. A modem 307 is connected between the WAN 331 and the system bus 310, and performs input and output of information between another apparatus connected to the WAN 331 via the modem 307 and the controller 11. A binary image rotating section 308 converts the direction of the image data before transmission. A binary image compression/decompression section 309 converts the resolution of the image data before transmission to a prescribed resolution or to a resolution matching the capacity of a party. The compression and decompression are carried out using a JBIG, MMR, MR or MH system. An image bus 330 is a transmission line for exchanging the image data, and consists of a PCI bus or IEEE 1394.

A scanner image processing section 312 carries out correction, processing and editing of the image data received from the scanner section 13 via a scanner I/F 311. Besides, the scanner image processing section 312 makes a decision on whether the received image data is a color original document data or a black-and-white original document data, or a text original document data or a photographic original document data. Then, it attaches the decision result to the image data. Such collateral information is referred to as attribute data. Details of the processing the scanner image processing section 312 performs will be described later.

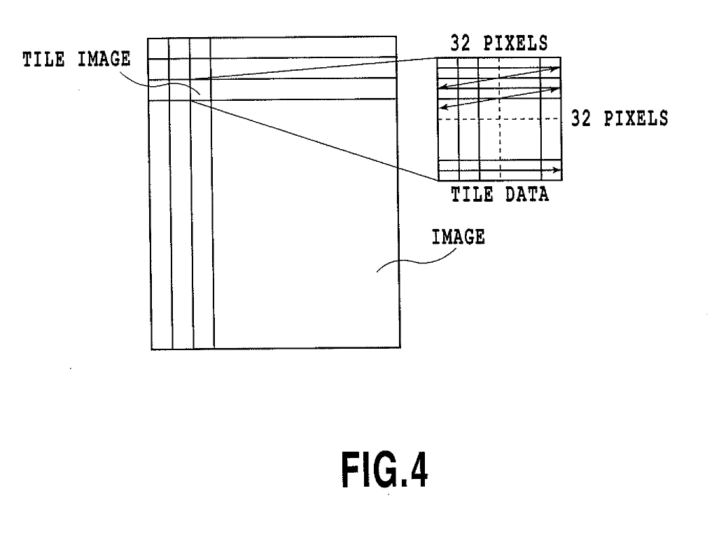

A compressing section 313 receives the image data, and divides the image data to blocks each consisting of 32 pixels×32 pixels. Each 32×32 pixel image data is referred to as tile data. FIG. 4 schematically illustrates the tile data. On the original document (paper medium before read) each region corresponding to the tile data is referred to as a tile image. To the tile data, average luminance information in the 32×32 pixel block and the coordinate position of the tile image on the original document are added as header information. In addition, the compressing section 313 compresses the image data consisting of a plurality of tile data. A decompressing section 316 decompresses the image data consisting of a plurality of tile data, and then develops into a raster, and delivers it to a printer image processing section 315.

The printer image processing section 315 receives the image data delivered from the decompressing section 316, and performs prescribed image processing on the image data with referring to the attribute data annexed to the image data. The image-processed image data is supplied to the printer section 14 via a printer I/F 314. Details of the processing carried out by the printer image processing section 315 will be described later.

An image converting section 317 performs prescribed converting processing on the image data. The processing section comprises the following processing sections.

A decompressing section 318 decompresses the received image data. A compressing section 319 compresses the received image data. A rotating section 320 rotates the received image data. A scaling section 321 performs resolution converting processing (from 600 dpi to 200 dpi, for example) of the received image data. A color space converting section 322 converts the color space of the received image data. The color space converting section 322 can carry out known groundwork skipping processing using a predetermined matrix or table, known LOG converting processing (RGB→CMY) or known output color correcting processing (CMY→CMYK). A binary-multivalued converting section 323 converts received binary gradation image data to 256-step gradation image data. In contrast, a multivalued-binary converting section 324 converts received 256-step gradation image data to binary gradation image data by a technique such as error diffusion processing.

A combining section 327 combines two received image data to generate a piece of image data. To combine two image data, such a method is applied that uses the average value of the luminance values of the corresponding pixels to be combined as a composite luminance value, or that uses the luminance value higher in the luminance level between the corresponding pixels as the luminance value of the composite pixels. In addition, a method of using darker pixels as the composite pixels is also possible. Furthermore, a method that determines the composite luminance value according to OR, AND or XOR operation between the pixels to be combined is also applicable. These combining methods are all well-known techniques. A thinning section 326 carries out resolution conversion by thinning out the pixels of the received image data, and generates image data with a resolution of ½, ¼, ⅛ and the like of the original resolution. A shifting section 325 gives a margin to the received image data or eliminates the margin.

An RIP 328 receives intermediate data generated from PDL code data transmitted from the PC 40 or the like, and generates (multivalued) bit map data. A compressing section 329 compresses the bit map data received from the RIP 328.

### <Scanner Image Processing Section 312>

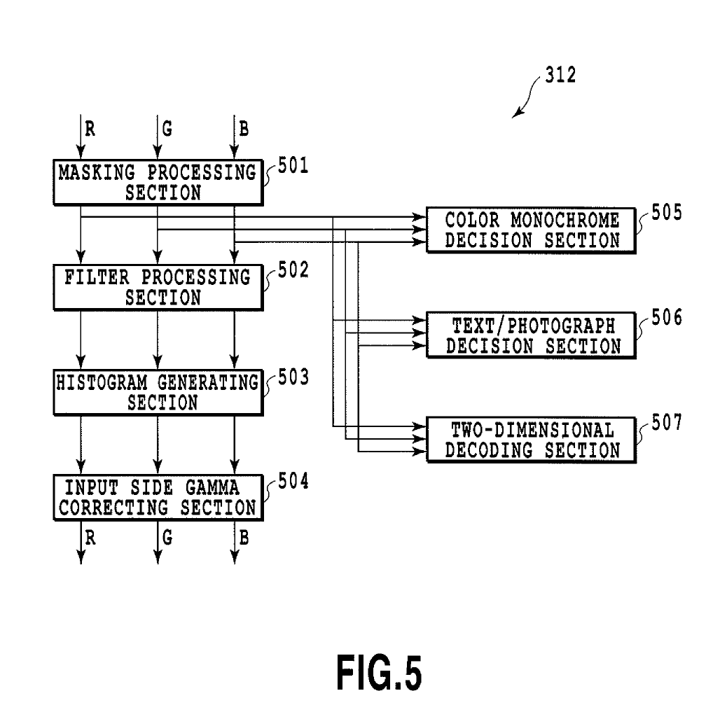

FIG. 5 shows an internal configuration of the scanner image processing section 312.

The scanner image processing section 312 receives the image data composed of RGB luminance signals each consisting of eight bits. The luminance signals are converted to standard luminance signals independent of the filter colors of a CCD by a masking processing section 501.

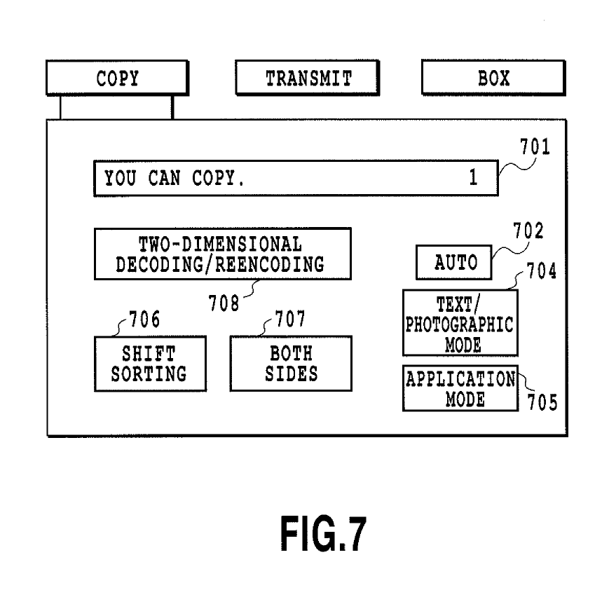

A filter processing section 502 arbitrarily corrects the spatial frequency of the received image data. This processing section performs arithmetic processing on the received image data using a predetermined 7×7 matrix, for example. Incidentally, in a copying machine or multifunction machine, it is possible to select a text mode, a photographic mode or a text/photographic mode as a copy mode by depressing a tab 704 on the operating screen of the image forming apparatus 10 shown in FIG. 7. When the user selects the text mode, the filter processing section 502 places a filter for text on the entire image data. When the user selects the photographic mode, it places a filter for photograph on all the image data. In addition, when the user selects the text/photographic mode, it adaptively switches a filter for each pixel in accordance with a text/photograph decision signal (part of the attribute data) which will be described later. Thus, a decision is made for each pixel on whether to place the filter for photograph or for text. As for the filter for photograph, such a coefficient that enables smoothing of only high frequency components is set to prevent image roughness. On the other hand, as for the filter for text, such a coefficient that enables considerable edge emphasis is set to sharpen the text.

A histogram generating section 503 samples the luminance data of the individual pixels constituting the received image data. More specifically, it samples the luminance data in a rectangular region enclosed from a start point to an end point designated in the main scanning direction and subscanning direction at a fixed pitch in the main scanning direction and subscanning direction. Then, it generates the histogram data from the sampled results. The generated histogram data can be used to estimate the groundwork level when carrying out the groundwork skipping processing. An input side gamma correcting section 504 converts to luminance data having nonlinear characteristics by using a table or the like.

A color monochrome decision section 505 decides on whether the individual pixels constituting the received image data are a chromatic color or an achromatic color, and annexes the decision results to the image data as a color monochrome decision information (part of the attribute data).

A text/photograph decision section 506 makes a decision on whether each pixel constituting the image data is a pixel constituting text, a pixel constituting a halftone dot, a pixel constituting text in halftone dots, or a pixel constituting a solid image according to the pixel value of each pixel and pixel values of its neighboring pixels. The pixels that cannot be classified to any one of them are pixels constituting a white region. Then, the decision results are annexed to the image data as text/photograph decision information (part of the attribute data).

A decoding section 507 detects, when the image data output from the data masking processing section 501 includes two-dimensional code image data, its existence. Then, it extracts information by two-dimensionally decoding the two-dimensional code image data.

### <Printer Image Processing Section 315>

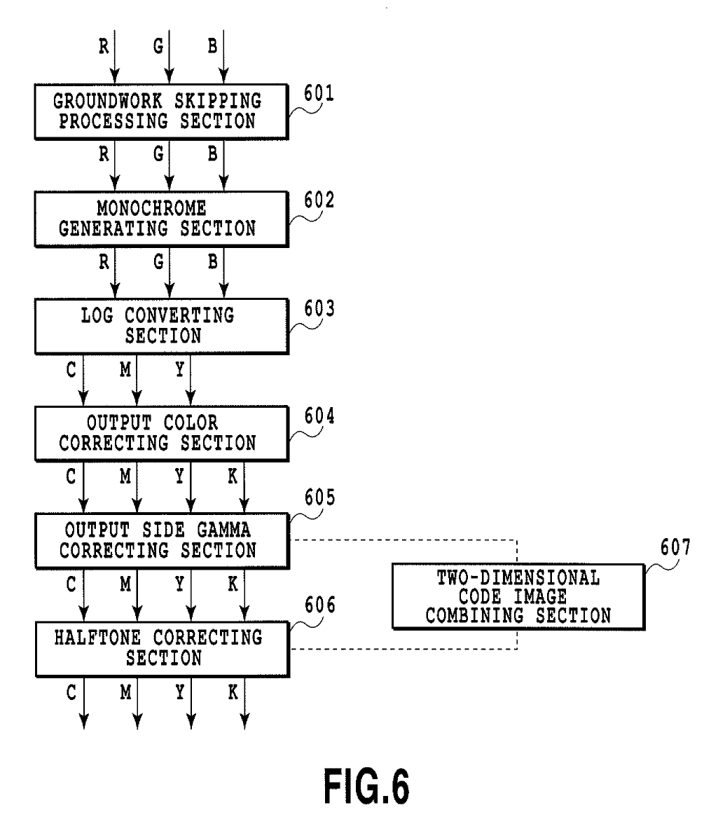

FIG. 6 illustrates a flow of the processing carried out in the printer image processing 315.

A groundwork skipping processing section 601 skips (removes) the groundwork color of the image data by using the histogram generated by the scanner image processing section 312. A monochrome generating section 602 converts the color data to the monochrome data. A Log converting section 603 carries out luminance level conversion. The Log converting section 603 converts the input RGB image data to CMY image data, for example. An output color correcting section 604 carries out output color correction. For example, it converts the input CMY image data to CMYK image data by using a predetermined table or matrix. An output side gamma correcting section 605 carries out correction in such a manner that the reflection level after the copy output is proportional to the signal value input to the output side gamma correcting section 605. A code image combining section 607 combines the two-dimensional code image data generated by the <two-dimensional encoding processing> which will be described later with the (original document) image data. A halftone correcting section 606 performs halftone processing in accordance with the number of gray levels of the output printer section. For example, as for the received high gradient image data, it carries out digitization to two levels or 32 levels.

The individual processing sections in the scanner image processing section 312 or in the printer image processing section 315 can output the received image data without adding any processing. To pass the data through without adding any processing in the processing section is also referred to as “through the processing section” or “through the processing” from now on.

### <Operating Screen>

Next, the operating screen of the operating section 12 of the image forming apparatus 10 will be described.

FIG. 7 shows an initial screen in the image forming apparatus 10.

A region 701 indicates whether the image forming apparatus 10 can accept copy or not, and a number of copies set (“1” in FIG. 7). An original document selection tab 704 is a tab for selecting the type of the original document. Every time the tab is depressed, one of the three types of pop-up selecting menus of the text, photographic and text/photographic modes is displayed. A finishing tab 706 is a tab for carrying out settings associated with various types of finishing (“shift sorting” is set in FIG. 7). A duplex setting tab 707 is a tab for carrying out settings associated with duplex reading and duplex printing. A reading mode tab 702 is a tab for selecting a reading mode of the original document. Every time the tab is depressed, one of the three types of pop-up selection menus of color/black/auto (ACS) is displayed. When the color is selected, color copy is performed, and when the black is selected, monochrome copy is carried out. In addition, when the ACS is selected, the copy mode is decided according to the monochrome color decision signal described above. A region 708 is a tab for selecting processing of two-dimensionally decoding and reencoding the two-dimensional code image. The two-dimensional decoding/reencoding processing will be described later.

### <Dividing/Two-Dimensional Encoding Processing>

The CPU 301 can perform control in such a manner as to generate the foregoing two-dimensional code image data by carrying out two-dimensional encoding processing of the original data (which includes the image information read from a memory card slot not shown or image data read from the scanner section 13, for example).

In addition, the CPU 301 can perform control in such a manner as to cut out the data with a predetermined data size from the original data in order to adjust the size of the two-dimensional code image data generated by the two-dimensional encoding processing. In addition, the data obtained by cutting out in this way is referred to as cutout data in the present embodiment.

Furthermore, the CPU 301 can perform control in such a manner as to generate a packet (which is referred to as “cutout packet” from now on) in which the prescribed identifier is added to the cutout data, and then to carry out two-dimensional encoding processing of the cutout packet. In addition, it can perform control in such a manner as to obtain each cutout packet from each two-dimensional code image data by performing two-dimensional decoding processing of the plurality of two-dimensional code image data, and then to reproduce the original data.

Moreover, the CPU 301 can perform control in such a manner as to transmit the generated two-dimensional code image data to a two-dimensional code image combining section 607 in the printer image processing section 315 via a data bus not shown.

The foregoing control (generating control of the two-dimensional code image and transmission control) is carried out by executing the programs stored in the ROM 303 or HDD 304.

### <Cutout Packet>

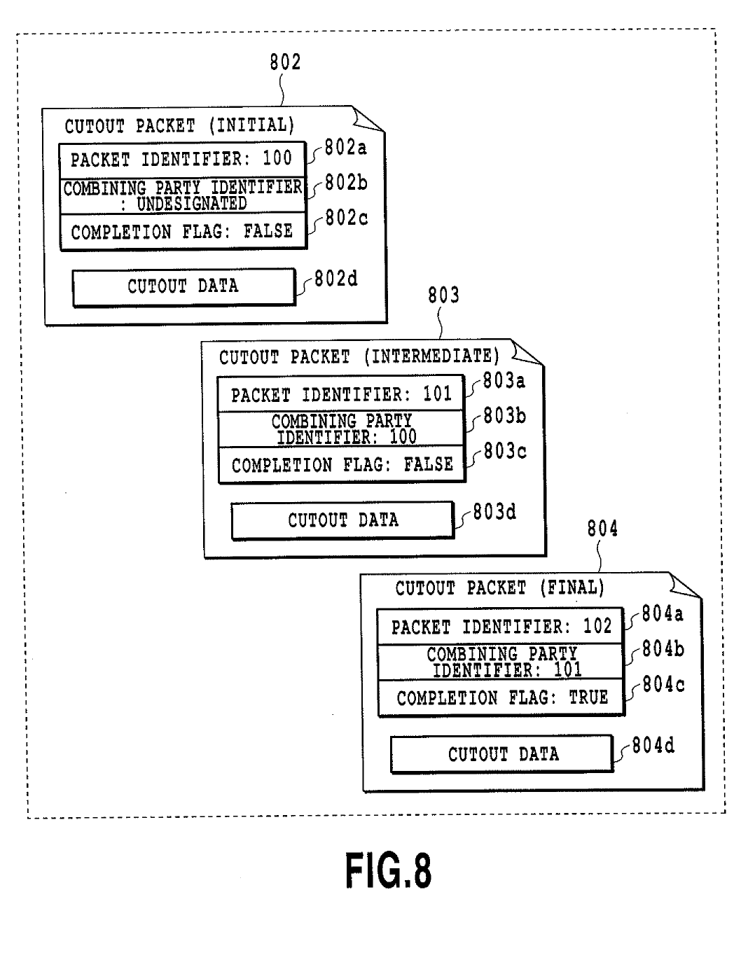

In FIG. 8, reference numerals 802, 803 and 804 each designate a cutout packet.

As described above, the cutout packet primarily includes two pieces of information: cutout data (802d, 803d, 804d) and a plurality of prescribed identifiers (referred to as “identifier group” from now on). Then, the identifier group includes the following three types of data: Packet identifier (802a, 803a, 804a) for uniquely identifying the cutout packet; Combining party identifier (802b, 803b, 804b) for uniquely identifying the cutout packet which is a combining party of the present cutout packet, that is, the cutout packet including the cutout data which is divided immediately before the divided data; and Completion flag (802c, 803c, 804c) indicating “whether the present cutout packet is a final packet or not” (which is called a final flag in the case of the final packet, and an ordinary flag in the other cases).

Here, the packet identifier will be described in more detail.

The packet identifiers of the cutout packets 802, 803 and 804 are designated by reference numerals 100, 101 and 102, respectively, as shown in FIG. 8. In addition, it is assumed that the combining party of the cutout packet 803 is the cutout packet 802, and the combining party of the cutout packet 804 is the cutout packet 803. In this case, the combining party identifier of the cutout packet 803 is 100, and the combining party identifier of the cutout packet 804 is 101.

As for the value of the completion flag in the present embodiment, it is represented as “true” when the present cutout packet is the final cutout packet, otherwise it is represented as “false”. When the cutout packet is only one, the cutout packet becomes the final cutout packet.

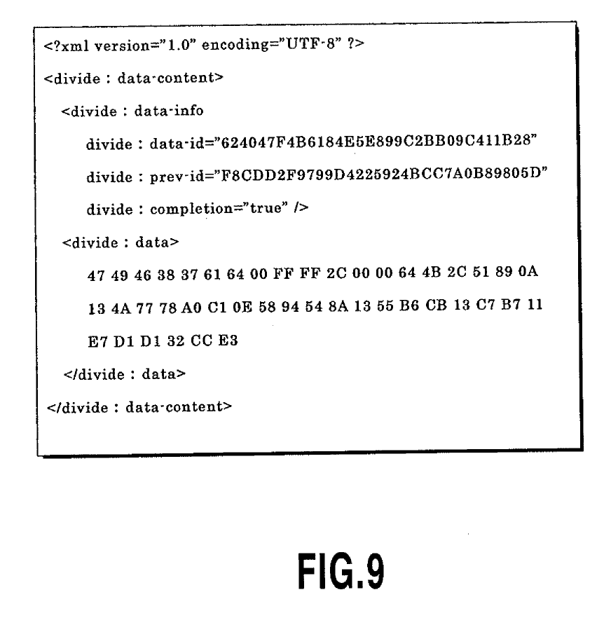

A concrete structure of the cutout packet is described as XML data as illustrated in FIG. 9, for example. In FIG. 9 “data-id” is the packet identifier, “prev-id” is the combining party identifier, and “completion” is the completion flag. In addition, a portion enclosed by <divide: data> and </divide: data> is the cutout data of the present cutout packet.

### <Flow of Dividing/Combining Processing>

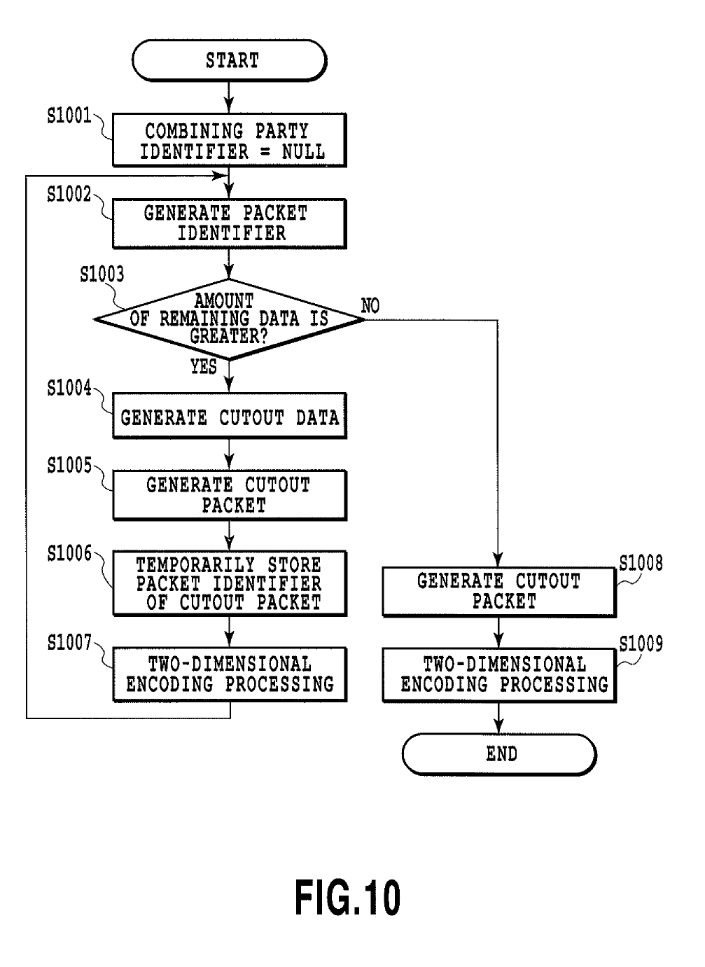

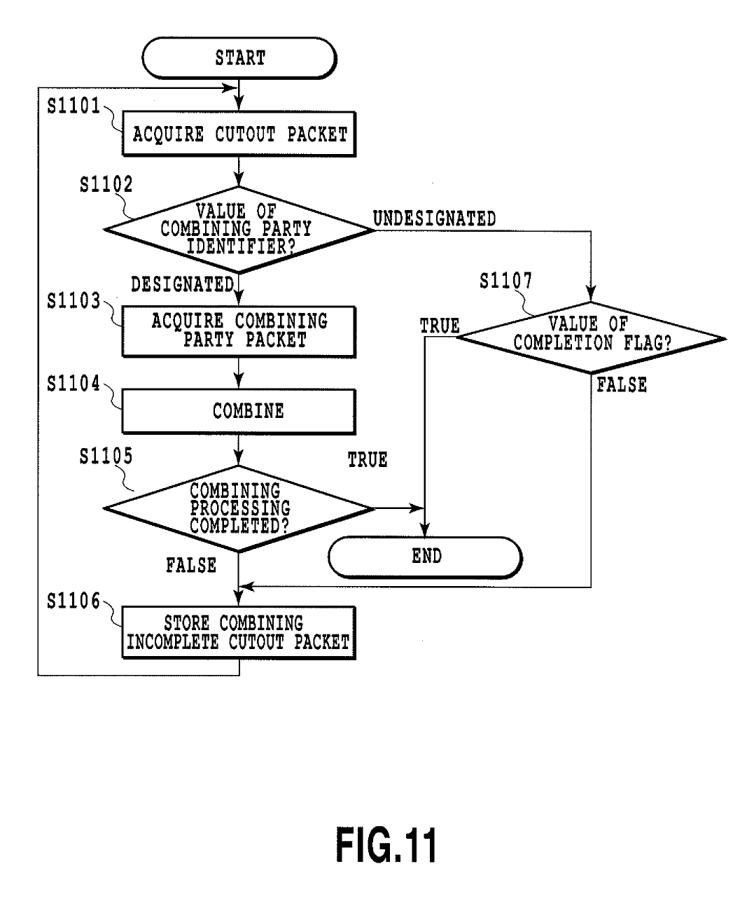

Next, referring to the flowcharts illustrated in FIG. 10 and FIG. 11, procedures of the dividing processing and combining processing of the original data will be described. As for intermediate data generated by the CPU 301 during the dividing processing and combining processing, they are assumed to be temporarily stored in the RAM 302 or HDD 304.

First, the dividing processing of the original data will be described with reference to FIG. 10. Incidentally, as the intermediate product (data) in the dividing processing described here, there are at least cutout data obtained by dividing from the original data, and its packet identifier and combining party identifier. In addition, the cutout data used in the present description correspond to a final letter “d” of the reference symbols of FIG. 8. Besides, the packet identifiers correspond to a final letter “a” of the reference symbols, the combining party identifiers correspond to a final letter “b”, and the completion flags correspond to a final letter “c” of the reference symbols.

At step S1001, the CPU 301 performs control in such a manner as to initialize a temporary area in the RAM 302 or HDD 304 for storing the combining party identifiers. In FIG. 10, “NULL” is set.

At step S1002, the CPU 301 performs control in such a manner as to generate the packet identifier for uniquely identifying each cutout packet.

At step S1003, the CPU 301 makes a decision as to whether the amount (data size) of the remaining data (at first, the remaining data=original data) is greater than a predetermined amount of data or not. Then the CPU 301 controls branching of the processing to step S1004 or to step S1008.

If a decision is made that the amount of the remaining data is greater than the predetermined amount of data at step S1003, the processing proceeds to step S1004.

At step S1004, the CPU 301 performs control in such a manner as to generate the cutout data by cutting out the prescribed amount of data from the original data, thereby obtaining the cutout data.

In addition, at step S1005, the CPU 301 performs control in such a manner as to generate the cutout packet from the cutout data obtained at step S1004, the packet identifier, the combining party identifier temporarily stored and the completion flag having the “false” value. If the cutout data is the initial cutout data, the combining party identifier indicates “undesignated” as in 802 of FIG. 8. Otherwise, as in 803, the combining party identifier indicates “a value equal to packet identifier minus one” (that is, the identifier of the packet of the combining party, which is the first previous packet). For the sake of simplicity, it is assumed in the present description that the packet identifier of the succeeding cutout packet takes a value equal to the packet identifier of the preceding cutout packet, which is the combining party, plus one. In the present embodiment, the packet identifier of the first previous cutout packet is temporarily stored as will be described below to use it as the combining party identifier of the cutout packet that is cut out at present. Accordingly, the value of the combining party identifier depends on the manner of setting the packet identifier.

At step S1006, the CPU 301 performs control in such a manner as to temporarily store the packet identifier of the cutout packet as the combining party identifier for the succeeding cutout packet.

At step S1007, the CPU 301 performs two-dimensional encoding processing on the cutout packet generated at step S1006. The CPU 301 can perform control in such a manner as to transmit the two-dimensional encoding-processed cutout packet to the two-dimensional code image combining section 607 in the printer image processing section 315 via a data bus not shown. After the processing at step S1007, the processing loops to step S1002.

On the other hand, if a decision is made at step S1003 that the amount of the remaining data is equal to or less than the predetermined amount of data, the processing proceeds to step S1008.

At step S1008, the CPU 301 carries out the same processing as that at step S1005, and performs control in such a manner as to generate the cutout packet (final cutout packet) with making the value of the completion flag “true”. Here, if the original data is not cut out at all, the combining party identifier indicates “undesignated”, otherwise the combining party identifier indicates the identifier of the combining party packet as in 804b.

Subsequently, the CPU 301 carries out the processing at step S1009, which is the same as the processing at the foregoing step S1007. Incidentally, as for the two-dimensional encoding processing at step S1007 and step S1009, an apparatus other than the controller 11 can perform it. In this case, the dividing processing and the two-dimensional encoding processing can be performed in parallel. Since the parallel processing enables cutout of the next data during the two-dimensional encoding processing, it can carry out the processing at higher speed.

Next, the combining processing will be described with reference to FIG. 11.

As the intermediate product in the combining processing of the present embodiment, at least zero or more cutout packets can exist that have not completed the combining processing. Here, such a cutout packet that has not completed the combining processing is referred to as a combining incomplete cutout packet. The combining incomplete cutout packet is a combination of one of more cutout packets. Accordingly, the combining incomplete cutout packet includes contents of one or more cutout packets (cutout data, packet identifiers and completion flags).

At step S1101, the cutout packet stored in the RAM 302 is obtained, the cutout packet is two-dimensionally decoded by two-dimensionally decoding the two-dimensional code image data by the two-dimensional decoding section 507 in the scanner image processing section 312.

At step S1102, the CPU 301 makes a decision from the cutout packet obtained at the foregoing step S1101 as to whether any combining party identifier is designated or not, and controls the branching of the processing to step S1103 or to step S1107.

If a decision is made at the branching processing at step S1102 that the present cutout packet designates the combining party identifier, the processing proceeds to step S1103. At step S1103, the CPU 301 retrieves from the temporary storing area the combining incomplete cutout packet having the packet identifier designated by the combining party identifier.

At step S1104, the CPU 301 performs control in such a manner as to combine the combining incomplete cutout packet obtained at step S1103 with the cutout packet obtained at step S1101. Unless the combining incomplete cutout packet designated by the combining party identifier is obtained at step S1103, a search is made as to whether a combinable one is present among the combining incomplete cutout packets. If the combinable one is present, it is combined, otherwise the combining processing is passed through.

At step S1105, the CPU 301 makes a decision as to whether the combining processing is completed or not, and controls the branching to step S1106 or to the end. That the combining processing is completed refers to the case where the value of the completion flag of the cutout packet after the combining at steps S1103 and S1104 is true, and the combining party identifier of the cutout packet after the present combining is “undesignated”. Here, as the combining party identifier of the combining incomplete cutout packet after the combining, the combining party identifier of the first cutout packet in a series of cutout packets combined is used. In addition, as the value of the completion flag, the value of the completion flag of the final cutout packet in the series of cutout packets combined is used.

At step S1106, since the combining processing has not yet been completed according to the decision at step S1105, the CPU 301 stores the data obtained as the output of the foregoing step S1104 in the temporary storing area as the combining incomplete cutout packet.

The processing at step S1107 is the one when a decision is made at the foregoing step S1102 that the present cutout packet has no indication of the combining party identifier. At the present step S1107, the CPU 301 makes a decision as to the truth or falsehood of the completion flag of the present cutout packet, and controls the branching of the processing to step S1106 or to the combining processing completion. At the present step S1107, the cutout packet as to which the CPU 301 makes a “true” decision is 804, and the cutout packet as to which it makes a “false” decision is 802 and 803.

The foregoing is the description about the controller 11.

Incidentally, it is sufficiently possible for a host computer (referred to as PC from now on) 40 to carry out the foregoing dividing processing of the original data and the two-dimensional encoding processing. Likewise, the PC 40 can also perform the foregoing combining and two-dimensional decoding processing if it can obtain the image data from an apparatus capable of optically reading an image such as the image forming apparatus 10 or 20 via the LAN 50 or via a USB or Centronics port. Each processing in the PC 40 will be described later in a second embodiment.

### <Operation at Press of Two-Dimensional Decoding/Reencoding Processing Tab 708>

Next, the two-dimensional decoding/reencoding processing will be described which is carried out when the user presses the two-dimensional decoding/reencoding processing tab 708 shown in FIG. 7 and then a start key.

At step S1201, the CPU 301 performs control in such a manner as to deliver the original document data read by the scanner section 13 to the scanner image processing section 312 via the scanner I/F 311 as the image data.

At step S1202, the scanner image processing section 312 performs the processing as shown in FIG. 5 on the image data to generate the new image data together with the attribute data. In addition, it annexes the attribute data to the image data. Furthermore, the decoding section 507 in the scanner image processing section 312 detects the two-dimensional code image data if it is present, and obtains information by two-dimensionally decoding the two-dimensional code image data detected. If a plurality of two-dimensional code images are present, it restores the original data by causing the combining processing to combine the data obtained by two-dimensionally decoding the individual two-dimensional code image data. Then, it delivers the resultant information of the two-dimensional decoding to the RAM 302 via the data bus not shown. When the processing at step S1202 has been completed, the processing at step S1208 and the processing at step S1203 are started simultaneously.

At step S1208, the CPU 301 generates the two-dimensional code image by reencoding the two-dimensionally decoded information, and performs control in such a manner as to deliver the two-dimensional code image data generated to the two-dimensional code image combining section 607 in the printer image processing section 315. In this case, if a single re-code image data cannot include all the information, a plurality of two-dimensional code image data are generated by the foregoing dividing processing and two-dimensional encoding processing. In addition, during the reencoding, new information can be added.

At step S1203, the compressing section 313 divides the new image data generated by the scanner image processing section 312 to the blocks with 32×32 pixels each, thereby generating the tile data. Furthermore, the compressing section 313 compresses the image data consisting of the plurality of tile data.

At step S1204, the CPU 301 performs control in such a manner as to deliver the image data compressed by the compressing section 313 to the RAM 302 to be stored. Incidentally, the image data is delivered to the image converting section 317 as needed to be subjected to the image processing, and is delivered to the RAM 302 to be stored.

At step S1205, the CPU 301 performs control in such a manner as to deliver the image data stored in the RAM 302 to the decompressing section 316. In addition, at this step, the decompressing section 316 decompresses the image data. Furthermore, the decompressing section 316 develops the image data consisting of the plurality of tile data after the decompression into a raster image. The image data developed into the raster image is delivered to the printer image processing section 315.

At step S1206, the printer image processing section 315 carries out image data editing in accordance with the attribute data annexed to the image data. The processing is the processing described before in connection with FIG. 6. At this step, the two-dimensional code image data generated at step S1208 is combined with the image data (of the original document). More precisely, the two-dimensional code image combining section 607 combines the image data (of the original document) output from the output side gamma correcting section 605 with the two-dimensional code image data generated at step S1208. In the course of this, since the two-dimensional code image data generated at step S1208 is overwritten on the original position of the two-dimensional code image in the original document, the original two-dimensional code image is eliminated with leaving only the two-dimensional code image data generated at step S1208. Then, in accordance with the number of gray levels of the output printer section, the halftone correcting section 606 performs halftone processing of the image data combined by the combining processing. The combined image data halftone-processed is delivered to the printer section 14 via the printer I/F 314.

At step S1207, the printer section 14 forms an image of the combined image data on output paper.

### Second Embodiment

### <Dividing/Encoding Processing by Information Processing Apparatus>

As described above, the dividing/two-dimensional encoding processing of the original data and the two-dimensional decoding/combining processing can be sufficiently performed by the information processing apparatus typified by a personal computer. In particular, it is a realistic operation for the host information processing apparatus to carry out the dividing/two-dimensional encoding processing, to convert the two-dimensional code image data generated to PDL data, and to transmit it to the image forming apparatus which is peripheral equipment and a communication party. Alternatively, it is also possible for the host information processing apparatus to carry out only the dividing processing, and for the image forming apparatus like the printer to perform the two-dimensional encoding processing. In this case, the host-side printer driver carries out the dividing processing. Then, the printer driver places the cutout packet generated by the dividing processing into a print instruction for the image forming, and delivers it to the image forming apparatus. Here, the foregoing PDL is an abbreviation of Page Description Language.

The most part of the dividing/two-dimensional encoding processing by the information processing apparatus (PC 40) is the same as the processing performed by the controller 11 in the first embodiment. Thus, assuming that the information processing apparatus carries out the processing of the controller 11 (see FIG. 10) in the same manner, its configuration will be mainly described in connection with the processing of the controller 11, which has already been described. As for the case where the host PC 40 carries out only the dividing processing, and the image forming apparatus like a printer performs the two-dimensional encoding processing, it will be described later. In addition, as for the processing of the image forming apparatus, since it is the same as that described before, its description will be omitted here.

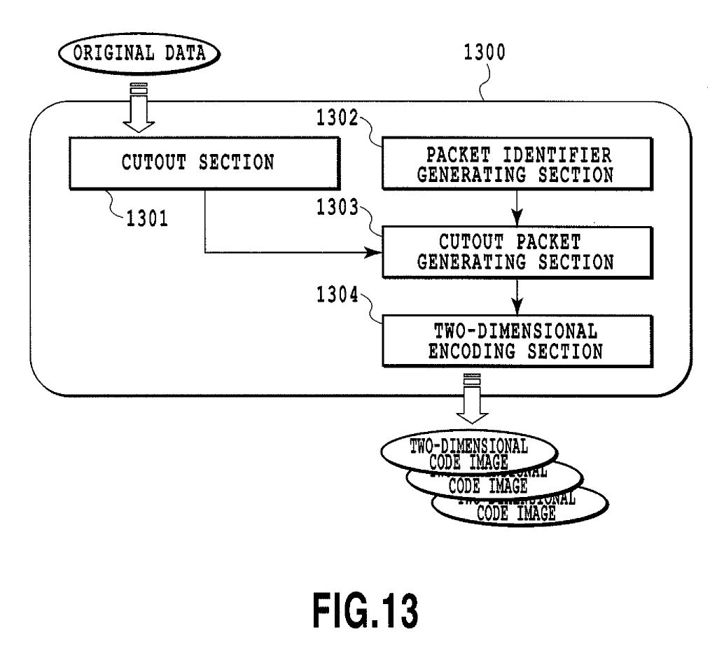

FIG. 13 is a block diagram showing a schematic configuration of individual processing sections for performing the dividing/two-dimensional encoding processing of the original data by an information processing apparatus 1300 (PC 40). In the following description, the processing in the flowchart described with reference to FIG. 10 is also written.

The information processing apparatus 1300 comprises a cutout section 1301, a packet identifier generating section 1302, a packet generating section 1303, and an encoding section 1304. Their operation is as follows.

The cutout section 1301 carries out cutout of the prescribed amount of data from the original data, that is, the amount of data used by a single two-dimensional code image (S1004).

The identifier generating section 1302 generates the packet identifier (S1002).

The packet generating section 1303 generates the cutout packet according to the information from the cutout section 1301 and packet identifier generating section 1302 (S1005 and S1008). During the generation of the cutout packet, the setting of the completion flag is also performed.

The encoding section 1304 encodes the cutout packet generated by the packet generating section 1303 (S1007 and S1009).

With the foregoing configuration, the PC 40 generates the two-dimensional code image data by two-dimensionally encoding the cutout packets, and delivers them successively to the prescribed image forming apparatus connected to the PC 40 every time they are generated.

When passing through the Internet or an intranet, the packets including the two-dimensional code image data transmitted from the PC 40 can sometimes arrive at the receiving side image forming apparatus in random order. Even if it receives the two-dimensional code image data in random order, the two-dimensional decoding/combining processing in accordance with the present invention can identify each two-dimensionally decoded cutout packet itself, and specify its combining party and the initial and final cutout packets, thereby being able to restore the original data easily as described before. In addition, since cutout packets that can be combined is combined first, it can complete the combining processing faster than the processing that combines them collectively after all the cutout packets have been prepared.

Next, a concrete configuration of the information processing apparatus of the present embodiment will be described.

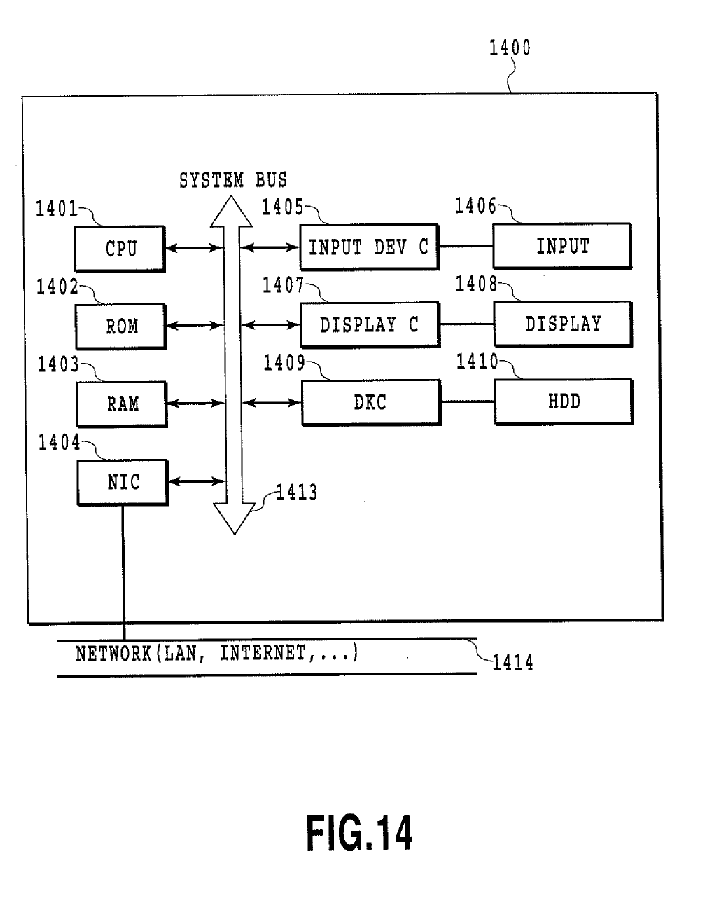

FIG. 14 is a block diagram showing an internal configuration of the ordinary information processing apparatus, which is denoted as PC 40 before. As for the foregoing dividing/two-dimensional encoding processing of the original data in the controller 11, it can be performed by the corresponding components of the PC 40. Accordingly, FIG. 14 will be explained below with primarily describing the corresponding components of the controller 11 shown in FIG. 3 as well.

In FIG. 14, the reference numeral 1400 designates the information processing apparatus in its entirety. The information processing apparatus 1400 (controller 11) includes a CPU 1401 (CPU 301) for executing software stored in a ROM 1402 (ROM 303) or an HDD 1410 (HDD 304), a large-scale storage such as a hard disk. The CPU 1401 is a control means for collectively controlling individual devices connected to a system bus 1413.

A RAM 1403 (RAM 302) functions as a main memory or work area of the CPU 1401. An external input controller (Input Dev C 1405 (operating section I/F 305)) controls an instruction input from an input section 1406 (operating section 12) composed of a keyboard, a mouse or the like included in the information processing apparatus. A display controller (Display C 1407 (operating section I/F 305)) controls the display on a display module (Display 1408 (operating section 12)) composed of a liquid crystal display, for example. A disk controller (DKC 1409) controls the input to and output from the HDD 1410.

A network interface card (NIC 1404) transfers data in two directions between it and other network equipment or file servers via a Network 1414. As the data to be transferred, it is needless to say that the foregoing two-dimensional code image data converted to PDL data is also included. As for the HDD 1410, it can sometimes be used as a temporary storing area of the information produced during the processing. In addition, the NIC 1404 corresponds to the network I/F 306 or modem 307 in FIG. 3, and the Network 1414 corresponds to the LAN 50 or WAN 331 in FIG. 3.

Next, a schematic configuration of the individual processing sections of the information processing apparatus 1400 and their operations will be described when the host information processing apparatus 1400 carries out the dividing processing and the image forming apparatus like the printer performs the two-dimensional encoding processing.

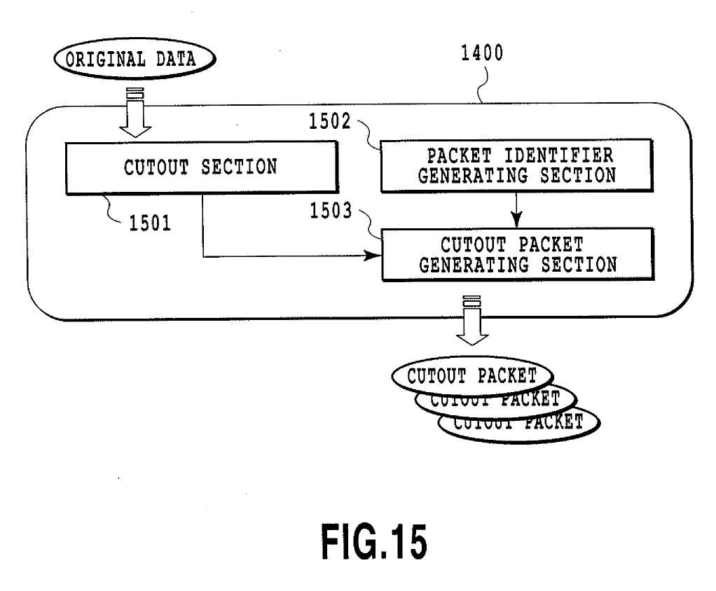

First, referring to a block diagram of FIG. 15, the schematic configuration of the individual processing sections of the information processing apparatus 1400 will be described.

The information processing apparatus 1400 has a configuration that eliminates the encoding section 1304 from the configuration of the information processing apparatus 1300 as shown in FIG. 13.

The information processing apparatus 1400 comprises a cutout section 1501, a packet identifier generating section 1502, and a packet generating section 1503. Their operations are as follows.

The cutout section 1501 carries out cutout of the prescribed amount of data from the original data, that is, the amount of data used by a single two-dimensional code image.

The identifier generating section 1502 generates the packet identifier.

The packet generating section 1503 generates the cutout packet according to the information from the cutout section 1501 and packet identifier generating section 1502. During the generation of the cutout packet, the setting of the completion flag is also performed.

With the foregoing configuration, the information processing apparatus 1400 delivers the generated cutout packets successively to the prescribed image forming apparatus connected to the present information processing apparatus 1400 every time they are generated.

When passing through the Internet or an intranet, the packets including the cutout packets transmitted from the information processing apparatus 1400 can sometimes arrive at the receiving side image forming apparatus in random order. Even if it receives the cutout packets in random order, the encoding/decoding/combining processing in accordance with the present invention can identify each cutout packet itself, and specify its combining party and the initial and final cutout packets, thereby being able to two-dimensionally encode the received cutout packets successively. In addition, during the two-dimensional decoding after the two-dimensional encoding, it can restore the original data easily. Furthermore, since cutout packets that can be combined is combined first in the combining processing, it can complete the combining processing faster than the processing that combines them collectively after all the cut out packets have been prepared.

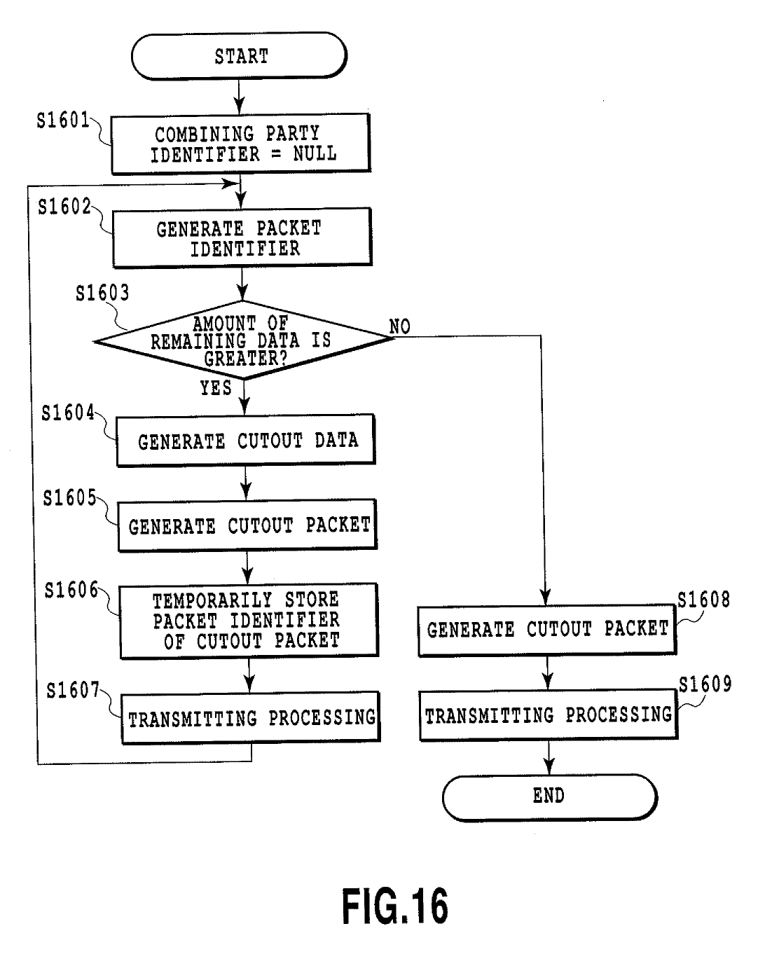

Next, referring to the flowchart of FIG. 16, the operation of the information processing apparatus 1400 of the present embodiment will be described.

### <Flow of Dividing Processing>

As for the intermediate data produced by the CPU 1401 in the dividing processing, they are assumed to be temporarily stored in the RAM 1403 or HDD 1410. As the intermediate product (data), there are at least cutout data, and its packet identifier and combining party identifier as described before. In addition, the cutout data used in the present description correspond to a final letter “d” of the reference symbols of FIG. 8. Besides, the packet identifiers correspond to a final letter “a” of the reference symbols, the combining party identifiers correspond to a final letter “b”, and the completion flags correspond to a final letter “c” of the reference symbols.

At step S1601, the CPU 1401 performs control in such a manner as to initialize a temporary area in the RAM 1403 or HDD 1410 for storing the combining party identifiers. In FIG. 16, “NULL” is set.

At step S1602, the CPU 1401 performs control in such a manner as to generate the packet identifier for uniquely identifying each cutout packet.

At step S1603, the CPU 1401 makes a decision as to whether the amount (data size) of the remaining data (at first, the remaining data=original data) is greater than a predetermined amount of data or not. Then, the CPU 1401 controls branching of the processing to step S1604 or to step S1608.

If a decision is made that the amount of the remaining data is greater than the predetermined amount of data at step S1603, the processing proceeds to step S1604. At step S1604, the CPU 1401 performs control in such a manner as to cut out the prescribed amount of data from the original data, thereby obtaining the cutout data.

Furthermore, at step S1605, the CPU 1401 performs control in such a manner as to generate the cutout packet from the cutout data obtained at step S1604, the packet identifier, the combining party identifier temporarily stored and the completion flag having the “false” value. If the cutout data is the initial cutout data, the combining party identifier indicates “undesignated” as in 802 of FIG. 8. Otherwise, as in 803, the combining party identifier indicates “a value equal to packet identifier minus one” (that is, the identifier of the packet of the combining party, which is the first previous packet). As for the combining party identifier, it is the same as that mentioned before.

At step S1606, the CPU 1401 performs control in such a manner as to temporarily store the packet identifier of the cutout packet as the combining party identifier for the succeeding cutout packet.

Subsequently, at step S1607, transmitting processing is performed. The cutout packet generated as described above is included in the prescribed instruction at step S1607, and is transmitted to the prescribed image forming apparatus connected to the present information processing apparatus 1400. The image forming apparatus generates the two-dimensional code image by two-dimensionally encoding the received cutout packets successively. In addition, after the processing at step S1607, the processing loops to step S1602 to carry out the cutout of the next data during the transmission of the cutout packet via the NIC 1404.

On the other hand, if a decision is made at step S1603 that the amount of the remaining data is equal to or less than the predetermined amount of data, the processing proceeds to step S1608.

At step S1608, the CPU 1401 carries out the same processing as that at step S1605, and performs control in such a manner as to generate the cutout packet (final cutout packet) with making the value of the completion flag “true”. Here, if the original data is not cut out at all, the combining party identifier indicates “undesignated”, otherwise the combining party identifier indicates the identifier of the combining party packet as in 804b.

The cutout packet generated is included in the prescribed instruction at step S1609, and is transmitted to the designated image forming apparatus connected to the information processing apparatus 1400. The image forming apparatus generates the two-dimensional code image by two-dimensionally encoding the cutout packets successively. In this way, the information processing apparatus 1400 performs the dividing processing, and the image forming apparatus carries out the two-dimensional encoding processing. This makes it possible to achieve the load distribution of the processing as compared with the case where the information processing apparatus 1400 performs both the dividing processing and two-dimensional encoding processing, thereby being able to carry out the processing at higher speed. In addition, the dividing processing is carried out in parallel with the transmission of the cutout packets, and this also can increase the speed of the processing.

### Third Embodiment

The present embodiment clearly shows that it can start the two-dimensional encoding before the RAM 302 receives the whole original data from the external apparatus. In the present embodiment, the two-dimensional decoding processing is the same as that of the embodiment 1. On the other hand, the two-dimensional encoding processing differs from that of the embodiment 1. Thus, the two-dimensional encoding processing will be described.

The CPU 301 can achieve its control in such a manner as to cut out, from the original data being received at present, data with a predetermined data size to be two-dimensionally encoded as a lump of two-dimensional code image.

First, it is assumed in the present embodiment that the RAM 302 receives the data (to be two-dimensional encoded) continuously from the external apparatus via the Network I/F. Detecting the reception of the data, (1) the CPU makes the following decision A at the time of detection (in many cases, not all the data is not yet received).

The CPU 301 makes a decision as to whether the amount of data in the RAM 302 is greater than the predetermined amount of data (corresponding to decision A). If it is greater, the CPU 301 cuts out the predetermined amount of data from the RAM 302 (it goes without saying that when the data is cut out, the amount of data in the RAM 302 is reduced by that amount cut out). Then the CPU 301 executes the processing from step 1004 to step 1007 in the embodiment 1 for the data cut out. In this way, a lump of two-dimensional code image data is generated. As a result, the two-dimensional code image data includes the ordinary flag. In addition, the two-dimensional code image data does not include the number of lumps (the number indicating how many lumps of the two-dimensional code image data are produced).

In contrast, if the amount of data in the RAM 302 is not greater than the predetermined amount of data, the CPU 301 makes a decision as to whether the reception of all the data (to be two-dimensional encoded) has been completed or not. If the reception has been completed, the CPU 301 cuts out all the data in the RAM 302, and executes the processing from step 1004 to step 1007 in the embodiment 1. In this way, the final lump of two-dimensional code image data is generated. As a result, although the two-dimensional code image data does not usually include the number of lumps (the number indicating how many lumps of the two-dimensional code image data are produced) clearly, when the first cutout packet begins from one, it includes the number of lumps eventually.

On the other hand, when the CPU 301 does not complete receiving all the data (to be two-dimensional encoded), it must wait for a prescribed time period. After waiting for the prescribed time period, the CPU 301 executes the foregoing (1) processing.

As described above, the present embodiment assumes the case where the RAM 302 receives the data continuously from the external apparatus via the Network I/F. Under such an assumption, the CPU 301 cuts out part of the data before completing the reception of all the data, and carries out two-dimensional encoding. Accordingly, the present embodiment can start the two-dimensional encoding at the timing earlier. The reason of being able to start the two-dimensional encoding at the timing earlier is that the present embodiment does not place the number of lumps in each of such two-dimensional code image data as would include the ordinary flag (each two-dimensional code image data that does not include the final flag).

Placing the number of lumps in each of such two-dimensional code image data as would include the ordinary flag will disable starting two-dimensional encoding until the number of lumps is calculated. In addition, the number of lumps cannot be calculated until the reception of all the data is completed. Accordingly, the two-dimensional encoding cannot be started until the reception of all the data is completed. As a result, a problem arises of delaying the start of the two-dimensional encoding. To solve such a problem, the present embodiment does not place the number of lumps in each of such two-dimensional code image data as would include the ordinary flag.

### Other Embodiments

The present invention is further applicable to a system comprising a plurality of apparatuses (such as a computer, interface equipment, reader, printer and the like) and to an apparatus comprising a single device (such as a multifunction machine, printer, fax machine and the like).

In addition, the object of the present invention is also achieved by a computer (or CPU or MPU) of the system or apparatus which reads, from a storage medium that stores program code for implementing the procedures of the flowcharts described in the foregoing embodiments, the program code and executes it. In this case, the program code itself read out of the storage medium implements the functions of the foregoing embodiments. Therefore the program code or the computer readable storage medium that stores/records the program code also constitutes part of the present invention.

As the storage medium for supplying the program code, a floppy disk, a hard disk, an optical disk, a magneto-optical disk, a CD-ROM, a CD-R, a magnetic tape, a nonvolatile memory card, a ROM and the like can be used.

In addition, as for the functions of the foregoing embodiments, the computer can implement them by executing the program read out. The “program execution” also includes the case where an OS and the like working on the computer according to the program instructions performs part of or all of the actual processing.

Furthermore, as for the functions of the foregoing embodiments, an expansion board inserted into the computer or an expansion unit connected to the computer can implement them. In this case, the program read out of the storage medium is written into a memory in the expansion board inserted to the computer or into the expansion unit connected to the computer, first. After that, according to the instructions of the program, the CPU in the expansion board or in the expansion unit executes part of or all of the actual processing. The processing executed by the expansion board or expansion unit can also implement the functions of the foregoing embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-117739, filed Apr. 26, 2007, which is hereby incorporated by reference herein in its entirety.

What is claimed is:

1. An image processing apparatus comprising:
cutout means for cutting out data with a data size predetermined with respect to a two-dimensional code image one by one from original data; and
means for assigning, to data cut out lastly from the original data, a final flag indicating that the data is final data, and for assigning, to other data, an ordinary flag indicating that the other data is not the final data.

2. The image processing apparatus as claimed in claim 1, further comprising:
means for allotting, to the cutout data every time the data is cut out by said cutout means, an identifier for identifying first previous cutout data as a combining party of the present cutout data, wherein
the flag assignment is carried out every time said cutout means cuts out the data.

3. The image processing apparatus as claimed in claim 2, further comprising:
means for generating a two-dimensional code image by two-dimensionally encoding information including the cutout data, the identifier, and the flag; and
image forming means for forming an image of the generated two-dimensional code image on a printing medium, wherein
while said means for generating is two-dimensionally encoding the cutout data, said cutout means cuts out data to be cut out after the cutout data.

4. The image processing apparatus as claimed in claim 2, further comprising:
transmitting means for transmitting data successively to a communication party, said data including the cutout data and at least the identifier and the flag which are added to the cutout data, wherein
while said transmitting means is transmitting the cutout data, said cutout means cuts out data to be cut out after the cutout data.

5. The image processing apparatus as claimed in claim 2, further comprising:
means for generating a two-dimensional code image by two-dimensionally encoding information including the cutout data, the identifier, and the flag; and
transmitting means for transmitting data of the two-dimensional code image successively to a communication party.

6. An image processing apparatus comprising:
receiving means for successively receiving data that includes data cut out from original data one by one and an identifier and a flag which are added to each cutout data, the identifier being used for identifying first previous cutout data as a combining party of the cutout data, and the flag indicating whether the cutout data is final cutout data or not;
means for generating a two-dimensional code image by two-dimensionally encoding information including the cutout data, the identifier and the flag which are contained in the data received by said receiving means; and
image forming means for forming an image of the generated two-dimensional code image on a printing medium.

7. An image processing apparatus comprising:
reading means for reading a plurality of two-dimensional code images that are formed on a printing medium by two-dimensionally encoding data that includes data cut out from original data one by one and an identifier and a flag which are added to each cutout data, the identifier being used for identifying first previous cutout data as a combining party of the cutout data, and the flag indicating whether the cutout data is final cutout data or not;
two-dimensional decoding means for two-dimensionally decoding the two-dimensional code images successively; and
combining means for combining, every time said two-dimensional decoding means performs two-dimensional decoding, a combination of combinable data first if the combination is found in the two-dimensionally decoded cutout data according to the cutout data, the identifier and the flag which are two-dimensionally decoded.

8. A method of controlling an image processing apparatus comprising:
a cutout step in which control means of said image processing apparatus cuts out data with a data size predetermined with respect to a two-dimensional code image one by one from original data; and
a step in which said control means assigns, to data cutout lastly from the original data, a final flag indicating that the data is final data, and assigns, to other data, an ordinary flag indicating that the other data is not the final data.

9. The method as claimed in claim 8, further comprising:
a step in which said control means allots, to the cutout data every time the data is cut out at the cutout step, an identifier for identifying first previous cutout data as a combining party of the present cutout data, wherein
the flag assignment is carried out every time the data is cut out at the cutout step.

10. The method as claimed in claim 9, further comprising:
a step in which said control means generates a two-dimensional code image by two-dimensionally encoding information including the cutout data, the identifier, and the flag; and
a step of forming an image of the generated two-dimensional code image on a printing medium under control of said control means.

11. The method as claimed in claim 9, further comprising:
a step of transmitting data successively to a communication party under control of said control means, said data including the cutout data and at least the identifier and the flag which are added to the cutout data.

12. The method as claimed in claim 9, further comprising:
a step in which said control means generates a two-dimensional code image by two-dimensionally encoding information including the cutout data, the identifier, and the flag; and
a step of transmitting data of the two-dimensional code image successively to a communication party under control of said control means.

13. A control method of an image processing apparatus comprising:
a step of successively receiving, under control of control means of said image processing apparatus, data that includes data cut out from original data one by one and an identifier and a flag which are added to each cutout data, the identifier being used for identifying first previous cutout data as a combining party of the cutout data, and the flag indicating whether the cutout data is final cutout data or not;
a step in which said control means generates a two-dimensional code image by two-dimensionally encoding information including the cutout data, the identifier and the flag which are contained in the data received at the step of receiving; and
a step of forming an image of the generated two-dimensional code image on a printing medium under control of said control means.

14. A control method of an image processing apparatus comprising:
a step of reading, under control of control means of said image processing apparatus, a plurality of two-dimensional code images that are formed on a printing medium, the two-dimensional code image being generated by two-dimensionally encoding data that includes data cut out from original data one by one and an identifier and a flag which are added to each cutout data, the identifier being used for identifying first previous cutout data as a combining party of the cutout data, and the flag indicating whether the cutout data is final cutout data or not;
a two-dimensional decoding step in which said control means two-dimensional decodes the two-dimensional code images successively; and
a step in which said control means combines, every time two-dimensional decoding is performed at the two-dimensional decoding step, a combination of combinable data first if the combination is found in the two-dimensionally decoded cutout data according to the cutout data, the identifier and the flag which are two-dimensionally decoded.

15. An apparatus comprising:
receiving means for receiving data to be subjected to two-dimensional encoding; and
means for performing two-dimensional encoding of cutout data in a manner that the cutout data constitutes a lump of two-dimensional code, by cutting out data with an amount of data to be subjected to the two-dimensional encoding as the lump of two-dimensional code from the data to be subjected to the two-dimensional encoding received by said receiving means, wherein
said means for performing the two-dimensional encoding starts its two-dimensional encoding before said receiving means receives all the data to be subjected to the two-dimensional encoding.

16. The apparatus as claimed in claim 15, wherein
said means for performing two-dimensional encoding carries out, for the data to be subjected to the two-dimensional encoding to constitute a final lump of two-dimensional code among the data to be subjected to the two-dimensional encoding received by said receiving means, the two-dimensional encoding, as the final lump of two-dimensional code, by adding a final flag to the data to be subjected to the two-dimensional encoding.

17. The apparatus as claimed in claim 16, wherein said means for performing two-dimensional encoding does not add information of the number of lumps of the two-dimensional codes to the data which is other than the data to be subjected to the two-dimensional encoding as the final lump, and which is to be subjected to the two-dimensional encoding as a lump.
